(19) United States
(12) Patent Application Publication
(10) Pub. No.: US 2006/0073348 A1
(43) Pub. Date: Apr. 6, 2006

(54) Electroplated fuel nozzle/swirler wear coat

(75) Inventors: Gilbert Farmer, Cincinnati, OH (US); James Anthony Groeschen, Burlington, KY (US)

Correspondence Address: MCNEES WALLACE & NURICK LLC, 100 PINE STREET, P.O. BOX 1166, HARRISBURG, PA, 17108-1166, US

(73) Assignee: GENERAL ELECTRIC COMPANY, Schenectady, NY (US)

(21) Appl. No.: 10/959,843

(22) Filed: Oct. 6, 2004

(51) Int. Cl. B32B 15/04

(52) U.S. Cl. 428/457

(57) ABSTRACT

A method of applying a wear coat to a surface portion of a fuel assembly. The engine component is dipped in wax and a desired portion of the wax is removed with a fluid. The removed wax exposes a surface of the component. This surface can then be electroplated with a wear coat while the non-exposed surfaces are protected from electrodeposition.

### BACKGROUND OF THE INVENTION

The present invention relates generally to wear coatings on gas turbine engine components. More particularly, this invention is directed to the application of wear coatings to selected portions of fuel nozzles and swirlers.

A gas turbine engine includes a compressor that provides pressurized air to a combustor wherein the air is mixed with fuel and burned for generating hot combustion gasses. These gasses flow downstream to one or more turbines that extract energy therefrom to power the compressor and provide useful work such as powering an aircraft in flight. In combustors used in aircraft engines, the fuel is typically supplied to the combustor through fuel nozzles positioned at one end of the combustion zone. A fuel nozzle is typically located within a surrounding assembly, known as a swirler. The fuel nozzles are bolted to the combustor case which does not see the hot combustion gasses. The swirler is configured to float radially in the combustor while being restrained in the axial direction. During engine transients, there are thermal gradients which result in axial and radial movement between the fuel nozzle tip and the swirler. It is generally desired that the fuel nozzle tip outer surface and the swirler inner bore have a 0.002 inch nominal gap, although surface contact is experienced.

Typically, a wear coating is adhered to these contacting surfaces to increase the usable life of the nozzles and swirlers. In the absence of a wear coating on these surfaces, the superalloy materials would wear and require a more frequent engine maintenance regimen. A primary concern when applying a wear coating to nozzle tips and swirlers is control of the surface portion where the wear coat is applied. Wear coat applied to an undesired surface portion of a nozzle or swirler could adversely affect the fuel or air flow within the combustor region.

These wear coatings are conventionally applied with a thermal spray technique to control the surface portion that the wear coating is applied thereon. While a thermal spray technique may be successful for a particular application, it requires that the components are wear coated individually. An adequate thermal spray process deposits about 0.0005 to 0.001 inches per pass of the thermal spray gun. To achieve a thickness of, for example, 0.003 inches, the thermal spray wear coat is typically applied in several passes. After application of several passes, the resulting thickness of a thermal spray wear coat may exceed the desired thickness and a additional machining operation may be required to remove some thermal spray wear coat.

A wear coat may also be applied with an electroplating process. To electroplate a wear coat on a selected surface portion of a component, the surface portion that is desired to remain free of wear coat must be masked. A mechanical masking means, such as covering a portion of the component with a nonconductive rubber mask, may be used where the rubber mask can be effectively used to partially cover the component. The geometry of some components, such as the swirler, does not allow the effective use of mechanical masking techniques. For these applications, the wear coat is typically not applied by electroplating.

Accordingly, there is a need for a method of wear coating gas turbine engine components that provides a predictable thickness of wear coat. A desirable method would allow for the simultaneous application of a wear coating on multiple components.

### SUMMARY OF THE INVENTION

The present invention is directed to applying a wear coating to a fuel nozzle of a gas turbine engine by electro-deposition. The electroplating process adheres a predictable coating thickness accumulation during a measured amount of time. One of the benefits of this process is the repeatability of the coating thickness for the amount of time the parts are in the bath. Because the parts are totally immersed in the electroplate bath, a uniform, repeatable thickness can be achieved, such that it is not necessary to measure the coating thickness of each part. A sampling plan can be used whereby one part per coating run can be measured with a micrometer and the other parts will generally vary no more than 0.0005 to 0.001 inches in thickness when compared to the part that is measured. Therefore, post coating processing time is reduced since it is not necessary to measure the coating thickness of each part.

In one embodiment, the present invention provides a method of wear coating a portion of a fuel assembly by masking the component in wax, and demasking a portion of the wax with a fluid. In another embodiment, the present invention provides a method of partially masking a component with wax, wherein the component is immersed, at least partially, in melted wax, and at least a portion of the wax coating is removed with a fluid from a portion of the component to provide an exposed surface of the component.

In yet another embodiment, the present invention provides a interim assembly for a gas turbine engine which includes a fuel assembly manufactured of a superalloy, having a first surface and a second surface with a temporary coating adhered to at least a portion of the first surface, and where the second surface has been stripped of any temporary coating with a fluid. In a further embodiment, the present invention provides an apparatus for electroplating at least a portion of a gas turbine engine component which includes a fixture to hold the component, a supply of a liquid phase material, and a fluid sprayer.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a partial sectional view of an aircraft engine combustor illustrating a fuel nozzle and swirler in accordance with the teachings of the present invention.

FIG. 2 is a partial view of the fuel nozzle assembly of FIG. 1, with the thickness of a wear coat on the fuel nozzle exaggerated for clarity.

FIG. 3 is a sectional view of the swirler of FIG. 1, with the thickness of a wear coat exaggerated for clarity.

FIG. 4 is a perspective view of a fuel nozzle, with an apparatus illustrating a preferred method of coating removal.

FIG. 5 is a sectional view of a swirler as an interim assembly, with the thicknesses of a wax coating and the wear coat exaggerated for clarity.

FIG. 6 is a perspective view of a carousel in accordance with the present invention.

FIG. 7 is a flowchart representing steps in accordance with the present invention.

### DETAILED DESCRIPTION OF THE INVENTION

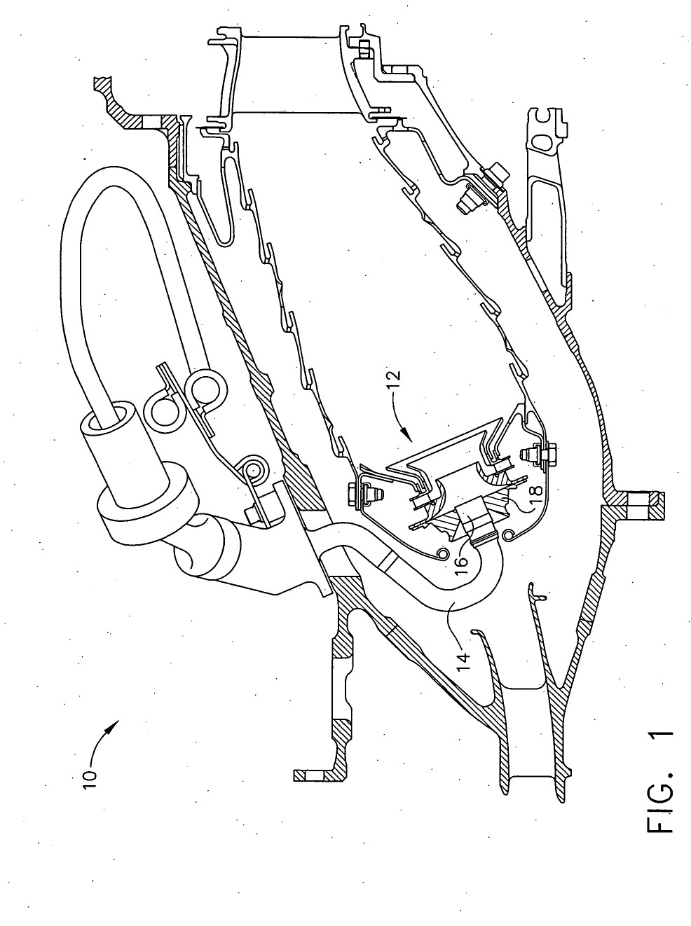

FIG. 1 shows the forward portion of a combustor 10 to include a fuel assembly 12 which includes a fuel supply line 14, and a fuel nozzle 16 positioned within a swirler 18. Preferably, fuel nozzle 16 and swirler 18 have a clearance of about 0.002 inches to allow relative movement therebetween.

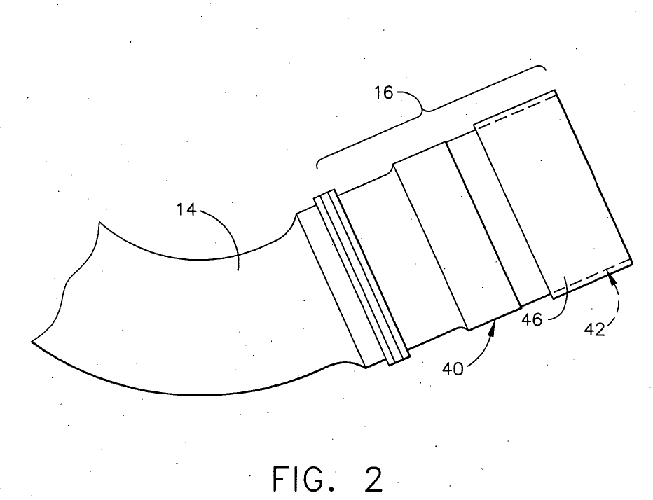

With reference to FIG. 2, a fuel nozzle 16 is shown to include a first surface portion 40 and a second surface portion 42. Second surface portion 42 is illustrated with an electroplated coating 46 bonded thereto. Electroplated coating 46 may be a wear coating, as discussed below.

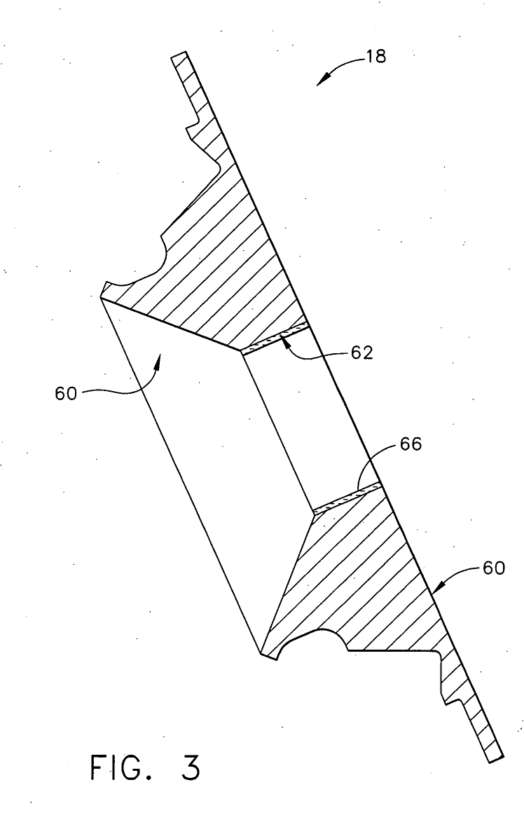

FIG. 3 illustrates a swirler 18 having a first surface portion 60 and a second surface portion 62. Second surface portion 62 is illustrated with an electroplated coating 66 bonded thereto.

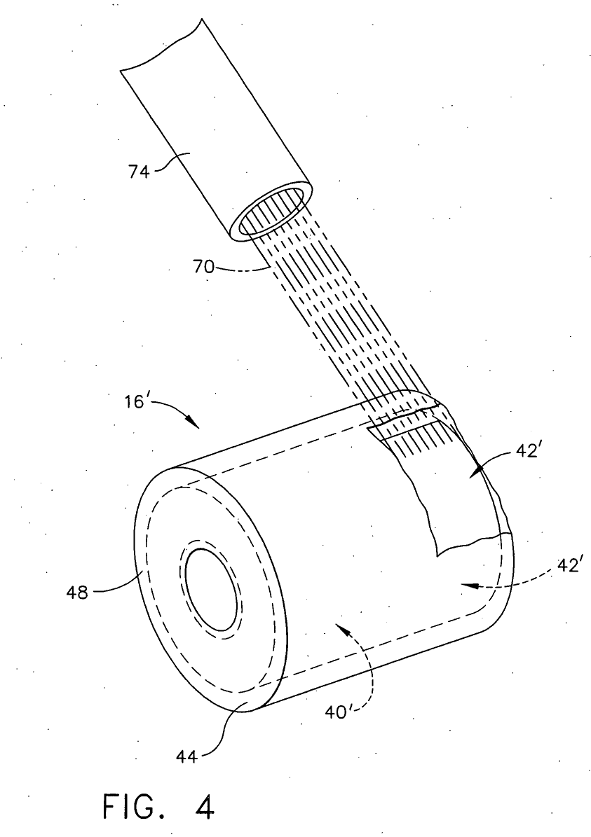

FIG. 4 illustrates a fuel nozzle 16′ in accordance with the teachings of the present invention. Nozzle 16′ is an interim assembly in the manufacture of nozzle 16 wherein the electroplated coating 66 has not been applied. Nozzle 16′ is shown to include a first surface portion 40′ and a second surface portion 42′. Nozzle 16′ has been coated in a mask 44 which comprises a wax 48, as discussed below to produce a component that will resist the attraction of an electrodeposited coating during a subsequent electroplating operation. As shown, a sprayer 74 directs a fluid 70 onto nozzle 16′ to partially demask wax 48 from second surface portion 42′. Preferably, sprayer 74 directs fluid 70 perpendicular to second surface portion 42′. In this manner, wax 48 can be removed, or demasked, from second surface portion 42′ without removing wax 48 from undesired areas of first surface portion 40′. As will be appreciated, sprayer 74 can be readily automated to demask wax 48 from second surface portion 42′. As will also be appreciated, sprayer 74 can be modified to demask specific surface shapes and geometries, including internal surfaces.

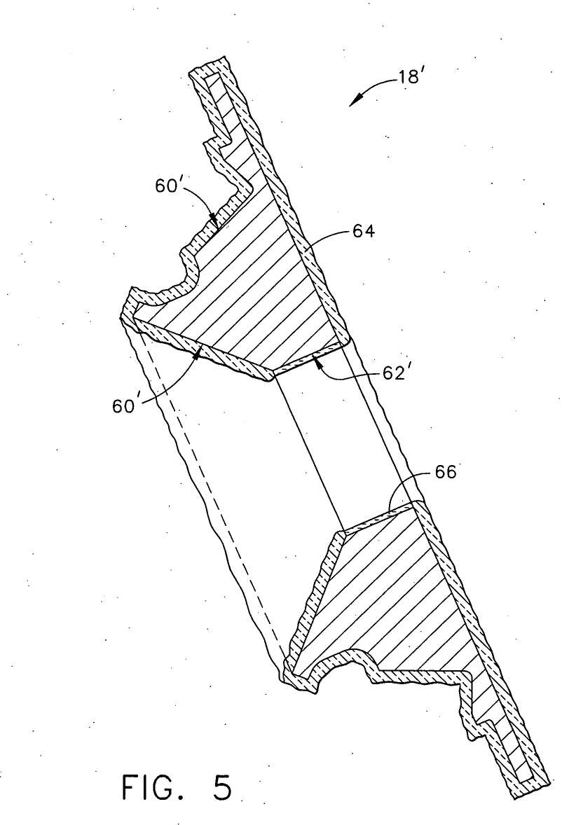

FIG. 5 illustrates a swirler 18′ as an interim assembly in the manufacture of swirler 18 and having a first surface portion 60′ and a second surface portion 62′. Second surface portion 62′ is illustrated with an electroplated coating 66 bonded thereto. First surface portion 60′ has a wax mask 64 adhered thereto. Mask 64 is preferably a masking material similar to mask 44.

During manufacture, a component such as swirler 18′ is coated in mask 64. Preferably, swirler 18′ is dipped in a melted wax (not shown) and at least partially coated. It would be appreciated that the mask 64 may be applied to swirler 18′ by means other than dipping, such as spraying or pouring wax 48 onto swirler 18′, or by any other equivalent means. As used in this application, wax 48 refers preferably to plater's wax, but can also be any suitable material that can be adhered to the surface of a metal part and prevent the accumulation of an electrodeposited coat thereon.

Preferably, the swirlers 18′ are completely immersed in liquid-phase wax 48 to ensure that the entire surface portions 60, 62 are in contact with wax 48. Also preferably, wax 48 is maintained at a temperature above the melting point of wax 48 which is higher than ambient and swirlers 18′ and nozzles 16′ are initially at a general ambient temperature of a range of about 50° F. to 90° F. As is known, the wax 48 will begin to solidify onto surface portions 60, 62, of swirlers 18′, for example, due to the temperature of surfaces 60, 62 being below the melting point of the wax 48. As the swirlers 18′ are removed from the wax 48, a liquid/solid film of wax 48 adheres to surface portions 60, 62. This film of wax 48 may completely solidify to form a mask 64 when exposed to an ambient temperature below the melting point of wax 48. Further exposure to ambient temperature may allow the mask 64 to cool to a temperature below the softening point. While this process is described as a single dip in wax 48, it would be appreciated that multiple or partial dips in wax 48 may form a suitable mask. After a suitable mask 64 is formed on swirler 18′, the wax 48 contacting second surface portion 62 is removed with a fluid, as discussed below.

As best seen in FIG. 4, fluid 70 is sprayed by sprayer 74 onto wax 48 and second surface portion 42′. Preferably, the fluid 70 is a liquid, and even more preferably water, that is at a temperature of above about 150° F. when the fluid 70 contacts wax 48. Also preferably, the fluid 70 is sprayed by sprayer 74 perpendicularly toward second surface portion 42′ in order to prevent the removal of wax 48 from first surface portion 40′. Even more preferably, the sprayer 74 maintains fluid 70 at a pressure of about 40 to 80 psi as the fluid 70 is sprayed onto wax 48 and second surface portion 42′. While the fluid 70 is described as water, it would be appreciated that other fluids, including a gas stream, could be used to demask wax 48 from second surface portion 42′. In particular, any equivalent fluid 70 that removes wax 48 by a combination of melting, or softening, and physical removal, may be utilized to partially demask nozzle 16′. It would also be appreciated that wax 48 may be removed by a high energy beam, such as a laser, or a gas that is directed onto second surface portion 42′ to remove the wax 48 adhered thereto.

With reference to FIG. 5, a swirler 18′ is shown after removal from an electroplate bath (not shown). In this embodiment, swirler 18′ has been dipped in wax 48, partially demasked as discussed above, and dipped in the electroplate bath to permit electrodeposition of electroplated coating 66.

As depicted in this embodiment, second surface portion 62′ of swirler 18′ is an inner cylindrical bore. It would be appreciated that the removal of wax 64 from second surface 62′ may be facilitated when demasking surfaces with confined geometries by a hydraulic process, such as fluid 70 spray, rather than a mechanical process, such as a blade. Furthermore, it would be appreciated that the use of a hydraulic process would provide a process which could be readily automated as the variation of parameters such as, for example, fluid temperature, fluid pressure, and fluid composition allow for optimization of the demasking.

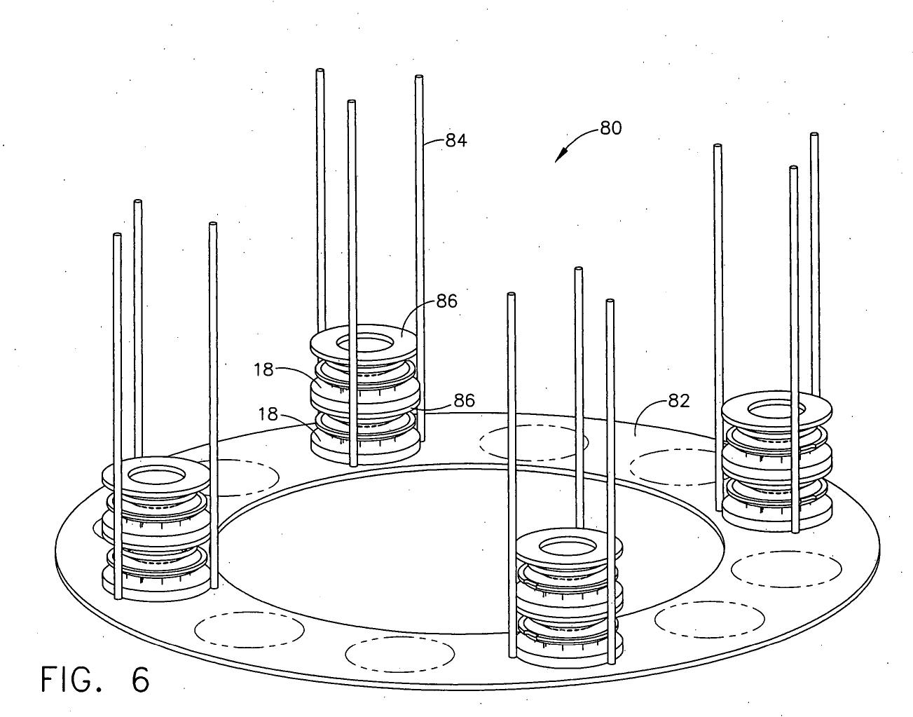

FIG. 6 illustrates an embodiment of a carousel 80, or a multi-attachment fixture, in accordance with the present invention. Carousel 80 is shown to include base plate 82, and a plurality of support prongs 84. Also shown are swirlers 18 and washers 88. The support prongs 84 are grouped together in sets of three in order to hold components, such as swirlers 18 and/or fuel nozzles 16, in place during electroplating. Each group of support prongs 84 are spaced apart from one another to maintain at least a minimum desired clearance between the sets of swirlers 18 and/or fuel nozzles 16. Washers 88 separate the swirlers 18 and/or fuel nozzles 16 to prevent the swirlers 18 and/or fuel nozzles 16 from being sealed to one another during the electroplating process. Prior to placement of swirlers 18 and/or fuel nozzles 16 into the carousel 80, support prongs 84, and washers 88 are all coated in wax to prevent them from being electroplated when immersed into an electroplate bath. As shown, carrousel 80 comprises a structural frame that supports fuel nozzles 16 and/or swirlers 18 and washers 88, while providing a rigid framework to facilitate dipping the components in the electroplate bath while maintaining a preselected distance therebetween. Preferably, carousel 80 is constructed of a metal, such as mild steel.

In operation, after wax removal from second surface portions 42′, 62′ as set forth above, fuel nozzles 16 and/or swirlers 18 are stacked within the sets of support prongs with washers placed between each individual fuel nozzle 16 or swirler 18 within a stack of components. After fuel nozzles 16 and/or swirlers 18 are placed into the carousel 80, the carousel 80 is positioned above the electroplate bath and dipped thereinto. Thus provided, carousel 80 can be used for electrodeposition.

In this manner, multiple components may electroplated while attached to a common carousel 80. The carousel 80 may be constructed of material such as plastic or rubber.

Preferably, the electroplated coating 46, 66 is formed with an electro-deposition process using a chromium carbide electroplate solution. The electroplated coating 46, 66 is an entrapment coating where chromium carbide particle are entrapped in a chromium coating. Electroplated coating 46, 66 is bonded, or adhered, to second surface portion 42, 62 to provide an abrasion resistant wear coat. Thus provided, the contacting surfaces of nozzle 16 and swirler 18 are protected from undesirable wear during engine operation.

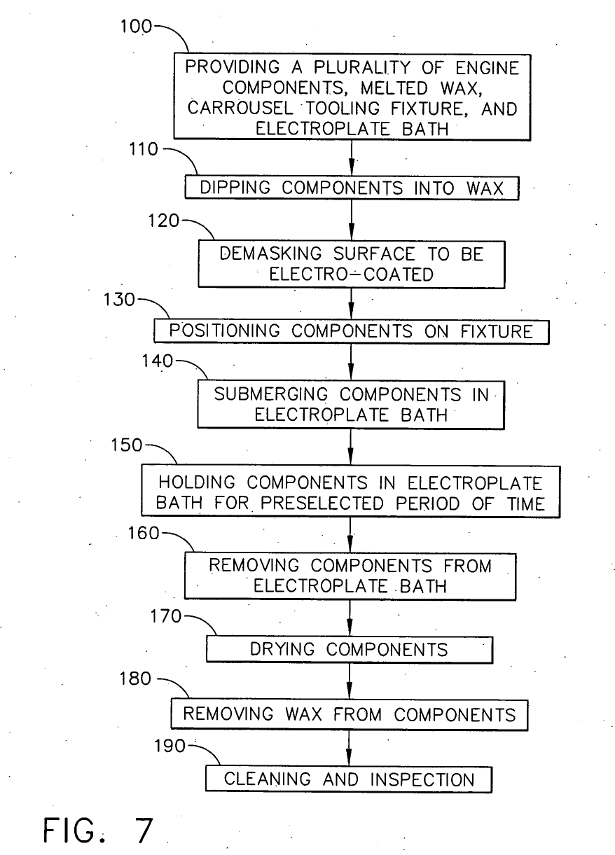

FIG. 7 illustrates the method of the present invention. Starting at Block 100, a plurality of engine components, melted wax, carrousel tooling fixture, and electroplate bath are supplied. In Block 110, the components are dipped into the wax. In Block 120, the surface to be electro-coated is demasked. In Block 130 the components are positioned on a fixture. In Block 140, components are submerged in the electroplate bath. In Block 150, the components are held in the electroplate bath for a preselected period of time. In Block 160, the components are removed from the electroplate bath. In Block 170, the components are dried. In Block 180, the remaining wax is removed from the components. In Block 190, the components are cleaned and inspected. Demasking or wax removal can be accomplished by any suitable process, including heating the articles to cause the wax to melt, or heating the article to a higher temperature to cause the wax to vaporize.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of applying a wear coat to a preselected surface portion of a fuel assembly, the method comprising:
masking the surface of the fuel assembly with a liquid-phase material to form a mask;
allowing at least a portion of the liquid-phase material to form a solid phase material;
demasking with a fluid, a portion of the mask from the preselected surface portion of the fuel assembly surface to provide an exposed surface portion of the component; and
applying the wear coat to the preselected surface portion of the fuel assembly.

2. The method of claim 1, wherein demasking with a fluid includes demasking with hot water.

3. The method of claim 2, further comprising directing the hot water onto the demasked portion of the mask.

4. The method of claim 1, wherein the fluid is sprayed at a pressure of about a range of 40 to 80 psi.

5. The method of claim 1, wherein demasking with the fluid includes demasking with a fluid that is at a temperature of more than about 150° F.

6. The method of claim 1, wherein demasking with the fluid is performed before the mask is cooled to an ambient temperature.

7. The method of claim 1, wherein the fuel assembly is a fuel nozzle.

8. The method of claim 1, wherein the fuel assembly is a swirler.

9. The method of claim 1, wherein applying the wear coat comprises electroplating.

10. The method of claim 1, wherein the material is a wax.

11. The method of claim 1, further comprising selecting at least one of interference surfaces between a nozzle and a swirler to be the preselected surface portion.

12. A method of applying a wear coat to a preselected surface portion of a fuel assembly, the method comprising:
masking the surface of the fuel assembly with a liquid-phase material to form a mask;
allowing at least a portion of the liquid-phase material to form a solid phase material;
demasking with an energy beam, a portion of the mask from the preselected surface portion of the fuel assembly surface to provide an exposed surface portion of the component; and
applying the wear coat to the preselected surface portion.

13. The method of claim 12, wherein the energy beam is a laser.

14. A method applying a wear coat to a fuel assembly of a gas turbine engine, comprising:
masking the fuel assembly by immersing the component, at least partially, in melted wax to form a mask; thereafter
demasking with a fluid, at least a portion of the mask from a portion of the component to provide an exposed surface of the component; thereafter
applying the wear coat to the exposed surface; and thereafter
removing any remaining mask from the fuel assembly.

15. The method of claim 14, further comprising directing the fluid toward the component.

16. The method of claim 14, wherein the fluid is sprayed at a pressure of about a range of 40 to 80 psi.

17. The method of claim 14, wherein removing with the fluid includes demasking with a fluid that is above about 150° F.

18. The method of claim 14, wherein the mask is removed by heating the fuel assembly.

19. The method of claim 18, wherein heating the fuel assembly causes the mask to melt.

20. The method of claim 19, wherein heating the fuel assembly causes the mask to vaporize.

21. An interim assembly for fuel assembly comprising:
a gas turbine engine component manufactured of a superalloy, having a first surface and a second surface; and
a temporary mask adhered to at least a portion of the first surface, wherein the second surface has been demasked of any temporary mask using a fluid.

22. The assembly of claim 21, wherein the temporary mask comprises a wax.

23. The assembly of claim 21, further comprising an electroplated coating adhered to the second surface after the second surface is demasked.

24. The assembly of claim 21, wherein the second surface is configured to matingly engage with a complementary gas turbine engine component.

25. An apparatus for electroplating a portion of a surface of a plurality of gas turbine engine components, the apparatus comprising:
a fixture having a plurality of attachment locations, each attachment location being configured to receive a plurality of components;
a supply of liquid phase material, the supply configured to apply a film of the liquid phase material to a surface of each component; and
a fluid sprayer configured to direct a fluid toward a preselected portion of the surface of each component to remove the material, after the liquid phase forms a solid phase, from the preselected portion of the surface.

26. The apparatus of claim 22, further comprising an electroplate bath containing an electroplate solution and configured to receive the fixture such that the components are immersed, at least partially, in the electroplate solution to apply an electroplated coating to the preselected portion of the surface.
